(19) United States
(12) Patent Application Publication
(10) Pub. No.: US 2012/0248040 A1
(43) Pub. Date: Oct. 4, 2012

(54) Inorganic Ion Exchange Adsorbent for Removing Toxic Trace Elements From Water

(75) Inventor: Natalia Chubar, Utrecht (NL)

(73) Assignee: universiteit utrecht Holding B.V., Utrecht (NL)

(21) Appl. No.: 13/496,202

(22) PCT Filed: Sep. 14, 2010
(86) PCT No.: PCT/NL2010/050583

§ 371 Date: Jun. 19, 2012

Related U.S. Application Data
(60) Provisional application No. 61/241,968, filed on Sep. 14, 2009.

(51) Int. Cl. B01J 20/04; C02F 1/42; B01J 20/30

(52) U.S. Cl. 210/660; 252/184

(57) ABSTRACT

The invention relates to an inorganic ion exchange adsorbent for removing toxic trace elements from water, comprising a sorbent comprising sol-gel generated double hydrous oxide of metal. In particular, for the metal a M²⁺ and M³⁺ (or M⁴⁺) metal is selected, preferably a metal from the group consisting of Al, Fe(III), Cr(III), Zr(IV), Fe(II), Zn, Mg, Mn(II), Co, Ni is selected. The invention further relates to a method of manufacturing an inorganic ion exchange adsorbent and a method of purifying water.

### FIELD OF THE INVENTION

The invention relates to an inorganic ion exchange adsorbent for removing toxic trace elements from water.

The invention further relates to a method of manufacturing an inorganic ion exchange adsorbent for removing toxic trace elements from water.

The invention still further relates to a method of removing toxic trace elements from water.

### BACKGROUND OF THE INVENTION

Water is the most important natural resource for our living planet predetermining sustainable development of human civilisation in all its aspects including human brain capacities. In the period of the accelerated economic development, natural resources (including water) were there to be used. Nowadays, all World nations have realised that water is in crisis. Water becomes a key political issue on the local, regional, national and global levels. Generalised problem is the same for rich and poor nations: quantity of water is decreasing and its quality is worsening. Water contamination is one of the main, common for all countries, water issues. WHO announced that at least 24% of global diseases are caused by environmental exposure. Contaminants of anionic chemical nature (such as, H₂AsO₄⁻, F⁻, Br⁻, BrO₃⁻, HSeO₄⁻ et al) are included in the priority list of toxic substances.

Arsenic contamination is one of the widely known health-related global problems. Exposure by higher arsenic concentrations (>100 μL⁻¹) can result it chronic arsenic poisoning called Arsenicosis or Black Foot disease. The most serious damage to health has taken place in Bangladesh, West Bengal and India. However, long-term exposure by smaller arsenic concentrations, such as the old drinking water standard for arsenic of 50 μg L⁻¹ is also dangerous for human beings as can result in cardiovascular diseases, endocrine system disorders and causes cancer. Therefore, EU and USA established a new standard of As in drinking water of 10 μg L⁻¹ which should have been achieved by water industries in 2004. New toxicological data obtained since 1998 indicated that the new standard is not save either. The State of New Jersey has recently proposed a new arsenic standard for drinking water of 5 μg L⁻¹.

Advancement of drinking water treatment scheme and replacement of chlorination by ozonation on the stage of water disinfection created another drinking water problem. It is formation of bromate from bromide originally containing in the purifying waters. While bromide is nutrient for humans, bromate is defined as dangerous toxicant. A harmful effect of this anion is its mutagenic and neurotoxic properties. Maximum permissible level of bromate in drinking water is 10 μg L⁻¹.

Selenium is a trace chemical element for humans and animals but an overdose of selenium may cause fatal toxicity which is quite similar to arsenic toxicity. Safe range of selenium concentration, which humans need before the concentration becomes toxic, is narrow and there is a critical indicator to allow water to be drinkable. Therefore, WHO, EU and governments of China and Russia pose a rigorous limit on the selenium content in drinking water which must be lower than 10 μg L⁻¹ (what is as strict as the standards for arsenic and bromate).

There are many discussions in European countries about the maximum permissible concentrations for boron and fluoride in natural and mineral waters. Both chemical elements are known as important nutrients for humans. Boron is an essential nutrient for plants and an essential element for many organisms, but can be toxic to aquatic and terrestrial organisms above certain concentrations. Regular use of irrigating water with more than 1 mg L¹ of boron is harmful for most of the plants. Long-term consumption of water and food products with increased boron content results in malfunctioning of cardiac-vascular, nervous, alimentary, and sexual systems of humans and animals. Blood composition undergoes changes, physical and intellectual progress of children decelerates and risk of the pathological births increases. Fluoride concentration in the range 0.5-1.5 mg L⁻¹ is generally considered to be beneficial to human beings. This conclusion is based on the chronic toxic effects on human health of excessive intake of fluoride. Long-term drinking of water containing higher than 1.5 mg L⁻¹ fluoride concentration can lead to fluorosis, which is a chronic disease characterized by mottling of teeth and softening of bones, ossification of tendons and ligaments. There is no mandatory maximum permissible concentration for boron in drinking water. US EPA adopted 0.6 mg L⁻¹ as drinking water standard for boron. Drinking water limit for boron concentration recommended by World Health Organization and several European countries is 0.3 mg L⁻¹. In Japan, the maximum permissible boron level is even lower: 0.2 mg L⁻¹. Some mineral waters can contain very high concentrations of boron. For instance, concentrations of boron in mineral waters of Carpathian regions of Ukraine is ranged 15-45 mg L⁻¹ and 30-75 mg L⁻¹.

New toxicological data, appearing in the literature on regular basis, lead to careful (re)considerations of drinking water maximum contaminant permissible concentrations (as well as, the standards for toxic chemical elements in ground and surface waters, soils, sediments, wastes et al) which are becoming stronger. In order to meet increasingly stronger standards, new highly selective, cost-effective and environmentally friendly materials and technologies are needed.

### SUMMARY OF THE INVENTION

It is an object of the invention to provide an improved inorganic ion exchange adsorbent for removing toxic trace elements from water, wherein such exchanger is cost-effective, environment friendly and has high efficiency for substantially reducing concentration of arsenate (H₂AsO₄⁻), arsenite (H₃AsO₃), fluoride (F⁻), bromide, (Br⁻), bromate (BrO₃⁻), borate (H₃BO₃), selenate (HSeO₄) in water. It will be appreciated that in general, the term ‘water’ will refer to drinking water from the water bearing layer. More in particular, it is an object of the invention to provide an ion exchange adsorbent which is capable of removing both neutral and anionic species of toxic elements, preferably of arsenic.

In accordance with the invention, the inorganic ion exchange adsorbent comprises a non-traditional sol-gel generated double hydrous oxide of a metal.

It is found to be advantageous to use sol-gel synthesis, which, at the room temperature, produces highly homogeneous, pure and strong materials (due to mixing on the atomic scale) with great compositional flexibility.

The sol-gel process refers to a process of evolution of inorganic networks through the formation of a colloidal suspension (sol) and gelation of the sol to form a network in a continuous liquid phase (gel).

Suitable metals that can be used for the ion exchange adsorbent based on double hydrous oxide according to the invention refer to combinations of the metals from two groups, such as a M²⁺ and M³⁺ (or M⁴⁺) metal, preferably, a metal from the groups consisting of Mg, Ca, Fe(II), Zn, Mn, Co(II), Ni (on one side, M²⁺) and Al, Fe(III), Zr, Cr(III) (on the other side, M³⁺ or M⁴⁺).

It is found that ion exchange adsorbents obtained from such materials in a double hydrous oxide form, for example double hydrous Mg—Al is capable of removing toxic elements, such as, arsenic from raw water in both the neutral and the anionic form.

It will be appreciated that the term ‘removing toxic elements from water’ refers to a process of a substantial reduction of the initial concentration of a toxic element down to 10 ppb, or even to 5 ppb or lower.

It is further found to be preferable to use double hydrous of the named metals to avoid sharp pH effect which is characteristic for adsorption of anions by individual hydrous oxides.

Preferably, Mg and Al are used for forming the double hydrous oxides. In such case they will be selective to, first of all, arsenic and boron species.

In accordance with the invention, the materials are obtained via non-traditional sol-gel synthesis which avoids using toxic and expensive metal alkoxides as raw substances. It will be appreciated that the term non-traditional sol-gel synthesis refers to a process wherein use of alkoxides is avoided.

Traditional sol-gel synthesis uses toxic and expensive metal alkoxide solutions (mostly, TEOS—tetraethyl-orthosilicates) as raw materials which results in elevated costs of manufacturing of the adsorbents for drinking water treatment scales. Besides, traditional sol-gel synthesis cannot be seen as a really environmentally friendly synthesis technique (due to the toxicity of the raw solutions).

It is found that substitution of the initial substances (simple inorganic salts instead of toxic and expensive metal alkoxides) could make the synthesis method suitable for drinking water industries. It provides, therefore, a cost-effective and easy to run in larger scale materials production for drinking water treatment plants application. The non-traditional sol-gel synthesis process may be suitably varied for varying the metal salt concentration, temperature, pH, mixing regime and additives. Preferably, a step of synthesis of the precursor (freshly prepared basic reagent containing a divalent metal to run hydrolysis of a three-valent (or four-valent) metal) and/or step-wise partial hydrolysis by weak bases are applied prior to the (final) step of hydrogel synthesis. The divalent metals (M²⁺), which may be used for the synthesis, are: Mg, Ca, Fe(II), Zn, Mn, Co(II), Ni. The three- and four-valent metals (M³⁺), which may be used for the synthesis, are: Al(III), Fe(III), Cr(III), Zr(IV).

The method of manufacturing of an inorganic ion exchange adsorbent for removing toxic trace elements from water, according to the invention, comprises the steps of:

synthesizing a hydrogel from precursor based on inorganic salt and/or a base of metal and/or an acid;

preparation of a porous ion exchange adsorbent from the hydrogel.

In a preferred embodiment of the method according to the invention, the precursor is synthesized depending on the wanted chemical composition and the structure of the final adsorbents. The precursor should be a weak base(s) (such as Mg(HCO₃)₂, Ca(HCO₃)₂ and similar) which may be contacted to any of the cations which hydrolyze: Al(H₂O)₆³⁺, Fe(H₂O)₆³⁺, Cr(H₂O)₆³⁺, ZrO(H₂O)₈²⁺ as their salts are Lewis acids. The inorganic salt for synthesis of basic precursor may be selected from the group consisting of chlorides, sulphates or nitrates of Mg, Ca, Fe(II), Zn, Mn(II), Co(II), Ni.

These and other aspects of the invention will be discussed in further detail with reference to drawings, wherein like reference signs relate to like elements. It will be appreciated that the drawings are presented for illustrative purposes and may not be used to limit the scope of protection of appended claims.

### BRIEF DESCRIPTION OF THE DRAWINGS

FIG. 1 presents schematically an embodiment of a process suitable for manufacturing of the inorganic ion exchanger according to the invention.

FIG. 2 presents pore size distribution for some sorbents developed in accordance with the invention showing improved sorptive capacity towards H₂AsO₄⁻ and higher BET specific surface area.

FIG. 3a presents isotherms of H₂AsO₄⁻ adsorption by Mg—Al hydrous oxides prepared from xerogels (3a-1 of FIG. 1);

FIG. 3b presents isotherms of H₂AsO₄⁻ adsorption by Mg—Al hydrous oxides prepared from hydrogels (3b of FIG. 1);

FIG. 3c presents isotherms of H₂AsO₄⁻ adsorption by Mg—Al hydrous oxides prepared from xerogels and hydrogels via hydrothermal treatment (3b of FIG. 1);

FIG. 4 presents a schematic embodiment of a suitable column for purifying water using the inorganic ion exchanger according to the invention.

### DETAILED DESCRIPTION OF THE DRAWINGS

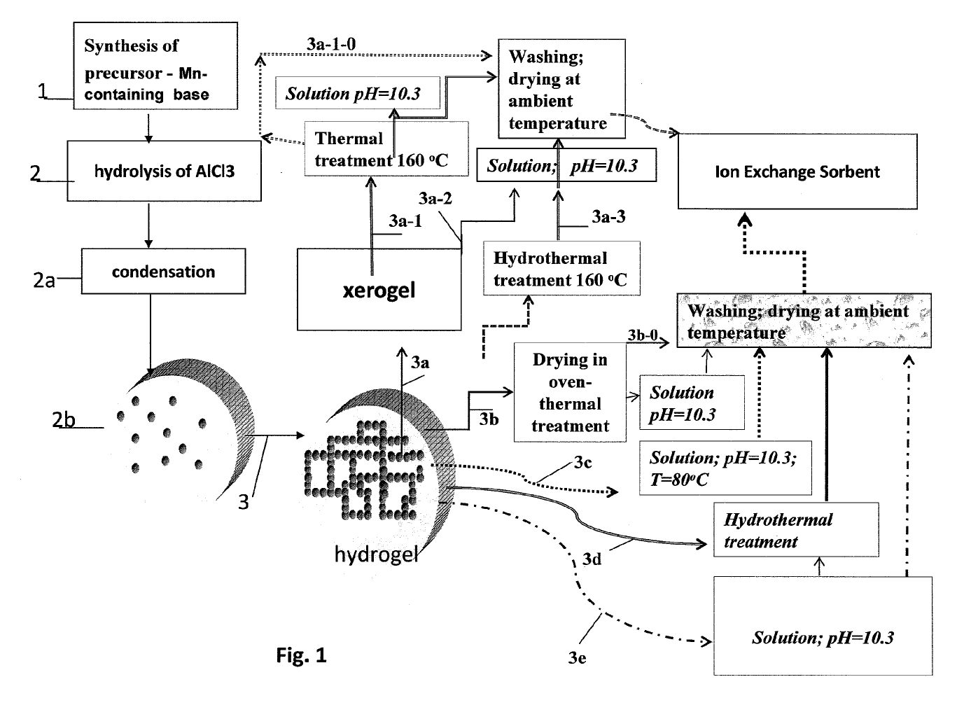

FIG. 1 presents schematically an embodiment of a process suitable for manufacturing of the inorganic ion exchange adsorbent according to the invention.

General scheme of the developed Mg—Al hydrous oxide obtaining is shown in FIG. 1. The whole process can be divided for two stages: first—synthesis of hydrogels (1-3 steps, FIG. 1) and second—preparation of porous ion exchange adsorbent from hydrogels (from 3a-3e to 4, FIG. 1).

Hydrogel (stage 3 in FIG. 1—the main precursor for production of inorganic ion exchangers) is the most critical step in the method of manufacturing the inorganic ion exchanger. Once this step is achieved, it is found to be possible to develop highly competitive adsorptive materials with a developed porous structure after careful testing of the best ways of xerogels (steps 3a-1, 3a-2 and 3a-3, FIG. 1) and hydrogels (3b, 3c, 3d and 3e, FIG. 1) treatments. Both hydrogels and xerogels (xerogels are hydrogels dried at the mostly ambient temperature) can be used to finalize preparation of the inorganic ion exchangers. The next steps are thermal (or hydrothermal) treatment(s), saturation by wanted exchangeable anions (such as OH⁻ groups), washing, drying at ambient temperature and, on the later stage, granulation of the materials for column adsorption studies.

### First Stage: Synthesis of Hydrogels

An example will be provided for manufacturing of an inorganic ion exchanger based on double Mg—Al hydrous oxides. It will be appreciated that in the course of such manufacturing, the difference of pH values of Mg and Al hydroxides precipitation must be taken account for. pH of full precipitation of Al and Mg hydroxides are 5.2 and 10.4 respectively.

It is known that there are no weak bases (e.g. soft neutralisers), which would be suitable to run hydrolysis of both salts simultaneously (due to too high pH of Mg hydroxides full precipitation). However, weak bases are necessary to run sol-gel reaction in a system and to avoid direct fast precipitation of hydrous oxides. Nevertheless, it was found feasible to use this difference and to direct the reaction the way to use a (basic) compound of one metal (in our case, Mg) to run hydrolysis of the second (transition) metal (e.g. Al) as aluminium chlorides are powerful Lewis acids.

Base (neutralising substance, such as Mg(HCO₃)₂) may be chosen (e.g. synthesized) depending on the wanted structure of the final materials. Layered double hydrous oxides have been considered as highly promising materials for various applications including adsorption and catalysis. These materials are known as anionic clays and as hydrotalcite-like materials where a partial M²⁺/M³⁺ (or M²⁺/M⁴⁺) substitution leading to excess of positive charge is balanced by anions, located, together with water molecules, in the interlayer. These materials can exchange the interlayer anions (inorganic: carbonate, nitrate, chloride or/and organic: carnoxylates, phosphonates and similar). The presence of carbonate in the reacting system could lead to formation of the layered hydrous oxides with carbonate in the interlayer space what would be the best option for the structure of the developing anion exchange adsorbents with additional anion exchange source besides surface OH⁻.

Accordingly, synthesis of hydrogels may be run in two steps.

1). Synthesis of Mg(HCO₃)₂ using solutions of MgCl₂.6H₂O (concentrations: 0.6; 1.2; 1.4 and 1.5 M) and solid NaHCO₃. Freshly synthesised reagents always increase a probability of sol-gel synthesis (in pure inorganic systems) possibility.

MgCl₂.6H₂O+2NaHCO₃=Mg(HCO₃)₂+2NaCl+6H₂O (1)

Synthesized Mg(HCO₃)₂ is the main reagent (e.g. weak base containing Mg which is to be in the composition of the double hydrous oxide) which is to be used as soon as possible to run hydrolysis of AlCl₃.6H₂O (Lewis acid) and obtain hydrogel. Duration of the reaction (1) depends on the temperature and the initial concentration of MgCl₂.6H₂O. At the ambient temperature (22±2° C.) and (1.4 or 1.5 M) MgCl₂.6H₂O, the reaction takes place over 4 hours. Heating up to 30-35° C. accelerates the reaction: Mg(HCO₃)₂ is synthesized in around 40 minutes but sol-gel synthesis is run more safely if Mg(HCO₃)₂ is synthesized at ambient temperature. Final product has the best surface chemical and absorptive properties (towards arsenate) if the conditions for this reaction are: the temperature is 22±2° C., concentration of MgCl₂.6H₂O solution is 1.4 and 1.5 M, solid NaHCO₃ and 4 hours contact time. The product is highly dispersive suspension of brightly white colour.

2) Hydrogels may be obtained by slow adding (step-wise) small portions of the freshly synthesized Mg(HCO₃)₂ suspension to the highly concentrated solution of AlCl₃.6H₂O which was constantly stirred by magnetic stirrer at 290-330 rtm. Considerable increase of stirring speed can destroy hydrogel or prevent its formation. Few concentrations of AlCl₃.6H₂O were tested: 1.50; 1.90; 2.20; 2.90 and 3.1 M. The gels were stronger when concentration of AlCl₃.6H₂O ranged 2.90-3.1 M. General scheme of the reaction leading to hydrogel formation is:

$$2 {AlCl}_{3} \cdot 6 {H}_{2} O\_ ( \frac{water}{solution} ) + 3 {Mg ( {HCO}_{3} )}_{2} \_ ( \frac{suspension\_containing}{NaCl + {H}_{2} O} ) \to \frac{hydrolysis \text{-} condensation}{sol \text{-} gelation \text{-} gel} \to 2 {Al ( OH )}_{3} \cdot {nH}_{2} O\_ ( \frac{hydrogel\_containing}{{Mg}^{2 +} , {Na}^{+} , {Cl}^{-} , {HCO}_{3}^{-}} ) \_ \qquad ( 2 )$$

Mechanism of hydrolysis of aluminium in water solutions is rather complex. In simplified way it could be shown as:

[Al(H₂O)₆]³⁺ [symbol] [Al(H₂O)₅OH]²⁺+H⁺ [symbol] [Al(H₂O)₄(OH)₂]⁺+2H⁺ [symbol] [Al(H₂O)₃(OH)₃]⁰(s) (3)

Hydrogels (FIG. 1, step 3) should be aged for 24 hours (like any hydrogel), then, treated by 3a, 3b, 3c, 3d or 3e accordingly to FIG. 1.

It will be appreciated that the process of synthesis of hydrogels, as explained above, may also be suitable as an intermediate step for manufacturing of ceramics.

### Second Stage: Preparation of Inorganic Ion Exchange Adsorbents

Hydrogels were treated by few ways (steps 3a, 3b, 3c, 3d and 3e, FIG. 1) and the final materials were tested for their adsorptive capacity to arsenate, and later on, to few other (toxic) anions. The structure of the promising materials was characterised. Hydrogels were treated by allowing them to dry at ambient temperature first, see sub-processes 3a-1, 3a-2 and 3a-3 (FIG. 1). In 24 hours after synthesis, hydrogels may be taken out of glasses and left for drying at ambient temperature. Hydrogels may become xerogels in 3-5 days (depending on ambient temperature). Different treatments may be carried out according to FIG. 1:

3a-1:

Xerogels may be treated thermally in oven at the gradually increasing temperature 80, 130 and 155° C.: 24 hours at 80 and 130° C. and 48 hours at 155° C. Thermally treated materials may be stirred then in the alkaline water solutions (containing one of the alkalis: Na₂CO₃, K₂CO₃, NH₄OH, NaOH and KOH or mixture of them) at pH=10.3 over 24 hours. pH adjust in the first 30 minutes. The materials may be washed using deionised water till stable pH, filtered and dried at ambient temperature.

3a-2:

Xerogels may be contacted to alkaline water solutions (containing one of the alkalis: Na₂CO₃, K₂CO₃, NH₄OH, NaOH and KOH or mixture of them) at pH=10.3 and stirred over 24 hours adjusting pH in the beginning, if necessary, then, washed by deionised water till stable pH, filtered and dried at ambient temperature.

3a-3:

Xerogels may be stirred first in the alkaline water solutions (containing one of the alkalis: Na₂CO₃, K₂CO₃, NH₄OH, NaOH and KOH or mixture of them) at pH=10.3 (adjusting pH in the beginning of the contact) over 24 hours, then, treated hydrothermally in the same solutions at 120 and 160° C. The materials may be washed, filtered and dried at ambient temperature.

3b:

Hydrogels were not supposed to dry at ambient temperature. Possibility of the accelerated drying of hydrogels (in oven followed by thermal treatment) may be used. Hydrogels (aged over 24 hours) may be placed in oven where the temperature was slowly increasing step-wise: 30, 40, 50, 60, 80, 100, 120 and 155° C. The following treatments may be carried out according to 3a-1: thermally treated materials are stirred then in the alkaline solutions, washed, filtered and dried.

3c:

Hydrogels (aged over 24 hours) may be stirred in the alkaline water solutions (containing one of the alkalis: Na₂CO₃, K₂CO₃, NH₄OH, NaOH and KOH or mixture of them) at pH=10.3 adjusted in the beginning and heated up to almost 100° C. during 3 hours. The heating may be switch off and the materials may be stirred yet for 24 hours at ambient temperature. They were washed, filtered and dried at ambient temperature.

3d:

Hydrogels (aged over 24 hours) may be placed in the alkaline water solutions (containing one of the alkalis: Na₂CO₃, K₂CO₃, NH₄OH, NaOH and KOH or mixture of them) with pH=10.3, and stirred for 24 hours at the ambient temperature. They may be treated hydrothermally at 120 and 160° C. for 24 hours, washed by deionised water, filtered and dried at ambient temperature.

3e:

Hydrogels (aged during 24 hours) may be placed in the alkaline solutions (containing one of the alkalis: Na₂CO₃, K₂CO₃, NH₄OH, NaOH and KOH or mixture of them) with pH=10.3 and stirred during 24 hours at ambient temperature. They may be washed, filtered and dried at ambient temperature. Thermal or hydrothermal treatment may be avoided.

3f (3a-1-0 or 3b-0):

The thermally treated xerogels (3a-1 and 3b, FIG. 1) may be washed in water without adjusting the pH to 10.3. Thermally treated xerogels (3a-1 and 3b) may accordingly be placed in water with the initial pH=10.3 (which was not adjusting and dropped to pH=8-9) and stirred for few hours. The materials may be washed and dried at ambient temperature.

Performance of the new materials for toxic anions removal-batch adsorption studies have been investigated. Solutions of pure for analysis reagent grade Na₂HAsO₄ (or other anions) in 0.01 M NaCl were contacted to the solids (Mg—Al ion exchangers) in Erlenmeyer flasks, which were kept on an orbital shaker at constant temperature (22° C., 200 rpm). The adsorbent concentrations (dose) were 2 g_{dw} L⁻¹. The initial arsenic concentrations varied from 10 to 500 mg[As] L⁻¹. pH of the solutions was kept stable. It was adjusted by NaOH or HCl solutions (0.01 and 0.1 M) until pH was not changing anymore. The supernatant solutions were filtered through membrane filters of 0.2 μm pore diameter. The experiments were run in triplicate. Uptake of arsenate was calculated according to:

$$q = \frac{( {C}_{o} - {C}_{eq .} ) V}{m} , \qquad ( 2 )$$

where q (mg[As] g_{dw}⁻¹) is the amount of arsenic sorbed per gram of dry weight of the adsorbent, Co (mg[As] L⁻¹) is the initial concentration of As, C_{eq} (mg[As] L⁻¹) is the final (or equilibrium) concentration of the anion in solution, V (L) the volume of solution and m (g_{dw}) is the dry mass of the adsorbent. The salts for the other anions adsorption tests were: NaAsO₂, NaF, NaBr, NaBrO₃, Na₂SeO₄ and B(OH)₃.

Concentrations of As and Se (before and after adsorption tests) as well as Mg and Al (to define a chemical composition of the materials) were analysed by Inductively Coupled Plasma Atomic Emission Spectroscopy (ICP-AES) and Inductively Coupled Plasma Mass Spectrometry (ICP-MS) techniques after appropriate dilution. Mg—Al hydrous oxides were dissolved first in 50% concentrated sulphuric acid, then, concentration of Mg and Al was analysed. Analysis of fluoride, bromate and bromide anions were carried out by Ion Chromatography.

Due to large number of xerogel and hydrogel treatments and many intermediate materials obtained on the stage of the materials development, the ion exchangers were tested first for their ability to remove toxic arsenate. Structure of the promising materials was characterised.

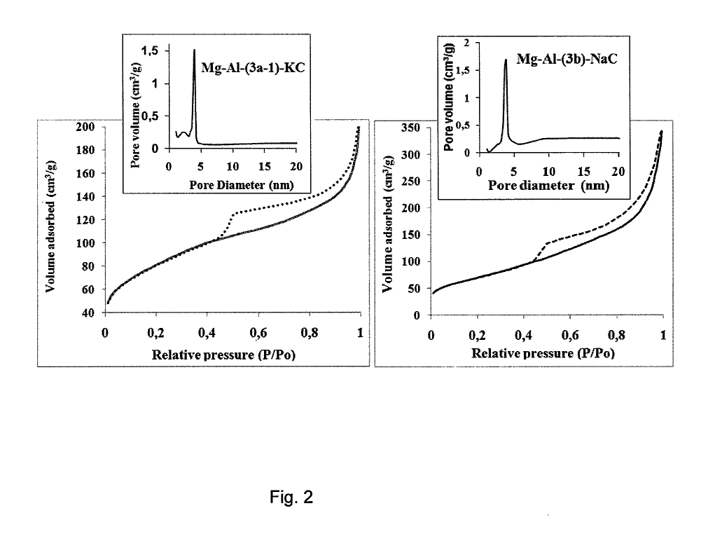

Texture characteristics of the developed Mg—Al hydrous oxides were investigated by N₂ adsorption-desorption measurements. FIG. 2 shows examples of nitrogen adsorption-desorption isotherms and pore diameter data for the thermally treated Mg—Al hydrous oxides. The materials are mesoporous. Specific surface area (S_{BET}) of the thermally treated adsorbents (3a-1 and 3b) is typically ranged from 155 to 290 m²g⁻¹. S_{BET} was very lower (6 m²g⁻¹) if the ion exchangers were not treated thermally (Mg—Al-(3e)-N).

It is further found that developed inorganic ion exchanger has substantially increase (relative) anion exchange capacity (drawn from potentiometric titration) which can range between 4.5 and 5.2 meq g⁻¹. The developed adsorbents have 2-2.5 times higher (relative) anion exchange capacity as compared to the state of the art ion exchangers. It is appreciated that an important property of the new adsorbents is their isoelectric point in alkaline pH (8.61) which suggests that the ion exchangers are capable of working for anions removal at the pH of purifying raw water. The known ion exchangers have a few times lower uptake capacity towards anions. The materials show also cation exchange capacity what means that they can also remove heavy metal cations from water.

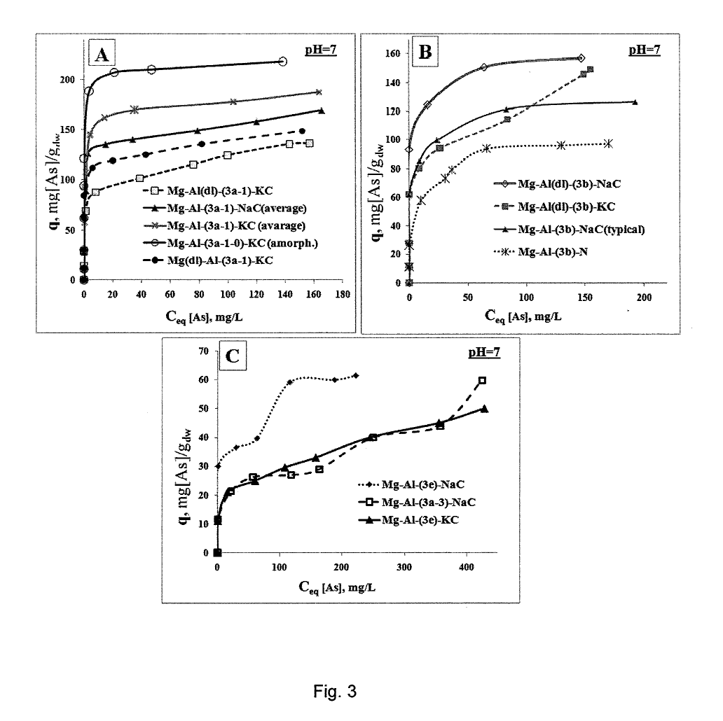

The new ion exchange adsorbents demonstrated very high removal capacity towards arsenate (plateau at isotherms) as well as high affinity to this toxic anion (steep isotherms) what is necessary if the materials are expected to work at very lower concentrations of the ions such as the new drinking water standards for arsenic. Equilibrium isotherms of H₂AsO₄ at pH=7 onto the new Mg—Al hydrous oxides are shown in FIG. 3.

Most of the ion exchangers based on Mg—Al hydrous oxides (FIG. 3a, FIG. 3b) demonstrated both important for adsorptive materials properties: higher adsorptive capacity and high affinity to arsenate. Mg—Al hydrous oxides prepared from xerogels by 3a-1 (FIG. 1) demonstrated the highest adsorptive capacity towards arsenate, FIG. 3a. It can reach 220 mg[As] g_{dw}⁻¹. For comparison: adsorptive capacity of conventional alumina and granulated ferric hydrous oxide at the same pH=7 are around 15 and 55 mg[As] g_{dw}⁻¹. If hydrogels were dried in oven first (3b, FIG. 1), what accelerated their preparation, removal capacity of the final products was still very higher, FIG. 3b. Hydrothermal treatment, which is widely used in material science for synthesis and improvement of surface chemical properties of the materials, decreases the removal capacity towards arsenate of Mg—Al hydrous oxides generated via 3a-3 and 3d (FIG. 1) as shown in FIG. 3c.

All types of xerogels and hydrogels treatments (shown in FIG. 1) lead to the final ion exchange adsorbents with higher or very competitive removal capacity to arsenate. In addition, it is found that adsorption of arsenate is very fast process. 100% of As(V) may be adsorbed with the inorganic ion exchanger according to the invention in 20-30 second (embodiment 3a-1) at the initial concentration of As(V) of 14.3 and 9.0 mg[As] L⁻¹. As expected, pH dependence of arsenic adsorption is very small what provide higher removal capacity at alkaline pH values of purifying drinking water.

Adsorption of arsenite, which is neutral at pH of purifying drinking water, by Mg—Al hydrous oxides treated thermally and hydrothermally, was also studied. It is noticed that all investigated materials exhibit nearly equal adsorptive capacity towards arsenite (ranged 20-35 mg[As] g_{dw}⁻¹) including hydrothermally treated adsorbents which showed much reduced removal capacity towards arsenate (FIG. 3c) as compare with the thermally treated Mg—Al hydrous oxides (FIG. 3c and FIG. 3b).

The ion exchangers based on Mg—Al hydrous oxides were tested for their adsorptive capacity towards the other toxic anions due to the developed mesoporous structure of the materials and their higher (relative) anion exchange capacity. Mg—Al hydrous oxides showed higher adsorptive capacity (more than 10 times higher as compare with the conventional alumina and hydrous ferric oxide at alkaline pH values) towards fluoride at both acidic and alkaline pH values, Table 1. Mg—Al hydrous oxide demonstrated also very competitive adsorption capacities towards bromate, bromide, borate and selenate, Table 1. It is further noticed that having proven high affinity to arsenic species in general, Mg—Al hydrous oxides according to the invention have demonstrated considerable removal capacity not only to As(V) but also to As (III). This quality of Mg—Al hydrous oxides can be employed to purify mineral and ground waters as well as to simplify the task of drinking water treatment plants on arsenic removal if they are present in raw drinking water. It will be further appreciated that porous properties of the resulting adsorbents and their ion selectivity can be regulated during synthesis and by chemical and physical modification of their surface: choosing the chemicals for hydrogels treatments and/or the temperature for thermal treatment. Preferably, the Mg—Al hydrous oxides are layered as layered materials are stronger as compare with the amorphous one.

Table 1 shows the range of the adsorptive capacities of an ion exchange adsorbent comprising Mg—Al hydrous oxides, according to the invention, towards fluoride, bromide, bromate, selenate and borate at the adsorbent dose of 2 g L⁻¹. Nine samples after various treatments were tested and the data range (from min to max value depending on the adsorbent) are shown in the table.

| Anions | H₃AsO₃ | BrO₃— | Br— | F— | HSeO₄— | H₃BO₃ |
|---|---|---|---|---|---|---|
| Initial | 170 | 334 | 199 | 212 | 127 | 204 |
| concentration, | | | | | | |
| mg L⁻¹ | | | | | | |
| Adsorption, | | 25-115 | 10-25 | 85-106 | | 17 |
| q mg g_{dw}⁻¹ | | | | | | |
| (pH = 4) | | | | | | |
| Adsorption, | 17-35 | | | | 15-77 | |
| q mg g_{dw}⁻¹ | | | | | | |
| (pH = 7) | | | | | | |
| Adsorption, | | 15-105 | 13-14 | 30-70 | 10-56 | 7-14 |
| q mg g_{dw}⁻¹ | | | | | | |
| (pH = 8) | | | | | | |

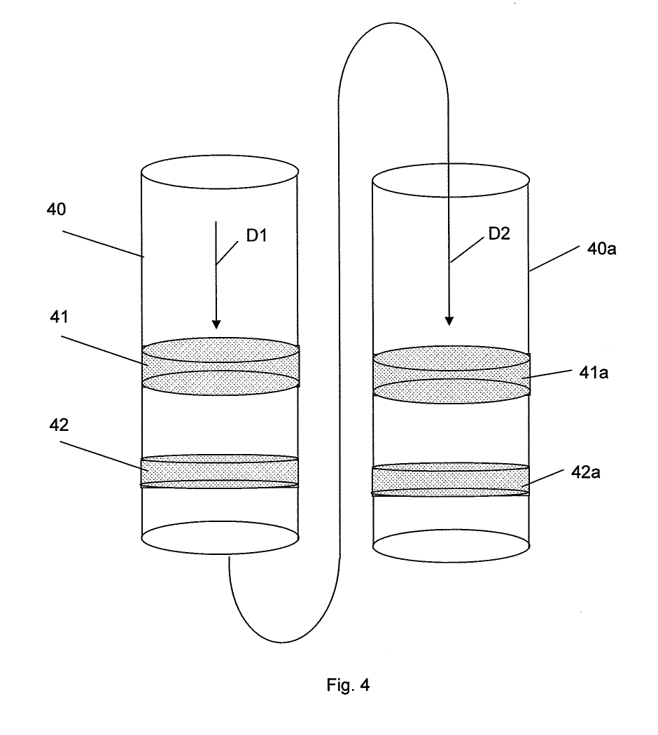

FIG. 4 presents a schematic embodiment of a suitable column system for purifying water using the inorganic ion exchanger according to the invention. It will be appreciated that although FIG. 4 schematically presents the system comprising two individual columns, any suitable number of columns may be used.

Each column may be manufactured from glass or other inert material and may be dimensioned to have about 1.2 cm in diameter and about 30 cm in length. However, any other relative or absolute dimensions may be used. Preferably, the column are operated using a down flow mode D1, D2. The volumetric flow rate may be set at 1 ml min⁻¹ (or it may be chosen empirically).

Each column may comprise one or more beds comprising the inorganic ion exchange adsorbents according to the invention. For example, in an embodiment utilizing two beds, a first bed 42, 42a may be positioned at 5 cm depth and a second bed 41, 41a may be positioned at 10 cm depth.

For testing: feed water, deionized water spiked with 50 μg[As] L⁻¹ (the old drinking water standard for As) or 100 μg[As] L⁻¹ with 0.01 M NaNO₃ as background electrolyte and pH in the range of 6.8-7.0 (or ranged pH=6.5-8.5 as allowed by drinking water regulations). It will be appreciated that in use the real purifying waters shall be used instead of the model solutions containing arsenic. It will be appreciated that the adsorbents according to the invention may operate in the state of the art ion exchangers with generally known operational parameters. It will be further appreciated that the adsorbents according to the invention may be used in low-end filters for domestic use.

It will be further appreciated that the ion exchange adsorbent may be suitably used in the batch adsorption approach for purification of water. For this purpose a suitable tank containing water may be provided with the adsorbent according to the invention, after action of which, the water may be filtered and/or subjected to flocculation.

While specific embodiments have been described above, it will be appreciated that the invention may be practiced otherwise than as described. In particular, other combinations of metals may be used for synthesizing inorganic sol-gel generated ion exchangers based on double hydrous oxides. The descriptions above are intended to be illustrative, not limiting. Thus, it will be apparent to one skilled in the art that modifications may be made to the invention as described in the foregoing without departing from the scope of the claims set out below.

1. An inorganic ion exchange adsorbent comprising non-traditional alkoxide-free sol-gel generated layered double hydrous oxide of a M³⁺ (or M⁴⁺) and a M²⁺ metal, wherein said layered double hydrous oxide is obtained using the reactions of:
$${M}^{2 +} {A}_{2}^{-} \cdot 6 {H}_{2} O + 2 {NaHCO}_{3} = {{M}^{2 +} ( {HCO}_{3} )}_{2} + 2 NaA + 6 {H}_{2} O$$
$$and$$
$$2 ( {M}^{3 +} ( or {\_M}^{4 +} ) ) {A}_{3}^{-} \cdot 6 {H}_{2} O\_ ( \frac{water}{solution} ) + 3 {{M}^{2 +} ( {HCO}_{3} )}_{2} \_ ( \frac{suspension\_containing}{NaA + {H}_{2} O} ) \to \frac{hydrolysis \text{-} condensation}{sol \text{-} gelation \text{-} gel} \to 2 ( {M}^{3 +} / {M}^{4 +} ) {( OH )}_{3} \cdot {nH}_{2} O\_ ( \frac{hydrogel\_containing}{{M}^{2 +} , {Na}^{+} , {A}^{-} , {HCO}_{3}^{-}} )$$
wherein A⁻ is an anion of an inorganic salt selected from the group consisting of a chloride (A⁻), a sulphate (A²⁻) or a nitrate (A⁻).

2. The adsorbent according to claim 1, wherein said M³⁺ (or M⁴⁺) and a M²⁺ metals are selected from the group consisting of: Al(III), Fe(III), Cr(III), Zr(IV), Fe(II), Zn(II), Mg(II), Mn(II), Co(II), Ni(II), Ca(II).

3. The adsorbent according to claim 2, wherein at least one of an inorganic salt, a base of a metal, and an acid is used for preparation of hydrogel.

4. The adsorbent according to claim 1, wherein the adsorbent is mesoporous.

5. The adsorbent according to claim 1, wherein pore size of the resulting adsorbent is in the range of 3-5 nm.

6. A method of manufacturing an inorganic ion exchange adsorbent, comprising non-traditional alkoxide-free sol-gel generated layered double hydrous oxide of a M³⁺ (or M⁴⁺) and a M²⁺ metal, comprising the steps of:
synthesizing a hydrogel from a precursor based on an inorganic salt and/or base of the corresponding metal and/or an acid;
preparation of the porous ion exchange adsorbent from the hydrogel, wherein said layered double hydrous oxide is obtained using the reactions:
$${M}^{2 +} {A}_{2}^{-} \cdot 6 {H}_{2} O + 2 {NaHCO}_{3} = {{M}^{2 +} ( {HCO}_{3} )}_{2} + 2 NaA + 6 {H}_{2} O$$
$$and$$
$$2 ( {M}^{3 +} ( or {\_M}^{4 +} ) ) {A}_{3}^{-} \cdot 6 {H}_{2} O\_ ( \frac{water}{solution} ) + 3 {{M}^{2 +} ( {HCO}_{3} )}_{2} \_ ( \frac{suspension\_containing}{NaA + {H}_{2} O} ) \to \frac{hydrolysis \text{-} condensation}{sol \text{-} gelation \text{-} gel} \to 2 ( {M}^{3 +} / {M}^{4 +} ) {( OH )}_{3} \cdot {nH}_{2} O\_ ( \frac{hydrogel\_containing}{{M}^{2 +} , {Na}^{+} , {A}^{-} , {HCO}_{3}^{-}} )$$
wherein A⁻ is an anion of an inorganic salt selected from the group consisting of a chloride (A⁻), a sulphate (A²⁻) or a nitrate (A⁻).

7. The method according to claim 6, wherein said M³⁺ (or M⁴⁺) and a M²⁺ metals are selected from the group consisting of: Al(III), Fe(III), Cr(III), Zr(IV), Fe(II), Zn(II), Mg(II), Mn(II), Co(II), Ni(II), Ca(II).

8. The method according to claim 7, wherein for the precursor is synthesized after a step of at least partial neutralization of an initial metal salt.

9. A method of removing toxic trace elements from water, wherein a column is provided with an ion exchanger according to claim 1.

10. The method according to claim 9, wherein water is substantially purified from arsenate, arsenite, fluoride, bromide, bromate, selenate, borate.

11. The method according to claim 10, wherein water is purified to respective concentrations of the toxic trace elements to value of 10 μg/L or lower.

12. The method according to claim 9, wherein water is purified to respective concentrations of the toxic trace elements to value of 10 μg/L or lower.

13. The adsorbent according to claim 1, wherein at least one of an inorganic salt, a base of a metal, and an acid is used for preparation of hydrogel.

14. The method according to claim 6, wherein for the precursor is synthesized after a step of at least partial neutralization of an initial metal salt.
